(19) United States
(12) Patent Application Publication
(10) Pub. No.: US 2010/0072049 A1
(43) Pub. Date: Mar. 25, 2010

(54) ELECTRICAL SWITCH

(75) Inventors: Wolfgang Suess, Koenigswalde (DE); Erwin Muders, Heidelberg (DE); Klaus-Peter Eppe, Waldbrunn (DE); Ralf Wieland, Waldbrunn (DE)

Correspondence Address: DARBY & DARBY P.C., P.O. BOX 770, Church Street Station, New York, NY, 10008-0770, US

(73) Assignee: ABB AG, Mannheim (DE)

(21) Appl. No.: 12/513,407

(22) PCT Filed: Oct. 26, 2007
(86) PCT No.: PCT/EP2007/009296

§ 371 Date: May 4, 2009

(30) Foreign Application Priority Data
Nov. 3, 2006 (EP) 10 2006 051 807.1

(51) Int. Cl. H01H 3/04

(52) U.S. Cl. 200/335

(57) ABSTRACT

An electrical switch with a main current path and an auxiliary current path comprises a first stationary contact piece, a first moveable contact piece, a contact lever, a second stationary contact piece, a second moveable contact piece, a contact carrier, a toggle switch, a first intermediate lever, a control lever, a second intermediate lever, a latching lever, a release lever configured to form a latching connection with the latching lever at a latching point, and a tripping spring.

This is a U.S. National Phase Application under 35 U.S.C. §171 of International Application no. PCT/EP2007/009296, filed on Oct. 26, 2007, which claims priority to German Patent Application No. DE 10 2006 051 807.1, filed on Nov. 3, 2006. The International Application was published in German as WO 2008/052702 A1 on May 8, 2008 under PCT 21 (2).

The invention relates to an electrical switch.

### BACKGROUND

Such a switch is described, for example, in DE 195 26 591 A1 and in DE 195 26 592 C2.

It has a main current path, in which a main contact point is located, which comprises a stationary and a movable contact piece, the movable contact piece being fastened on a contact lever arm mounted pivotably on a fixed rotary spindle.

Furthermore, a generic switch has an auxiliary current path, in which an isolating contact point, also referred to as an auxiliary contact point, is located, which likewise comprises a stationary and a movable contact piece, the movable contact piece being fastened on a contact carrier mounted pivotably on a fixed rotary spindle, with the current being commutated from the main current path onto the auxiliary current path in the event of a short circuit.

The main contact point and the auxiliary contact point can be actuated using a switching lever and a switching mechanism, which is mounted with its individual components in a printed circuit board holder.

The contact lever is a twin-armed lever, whose arm lying opposite the movable contact piece is acted upon by a control lever, whose other end is connected in articulated fashion via a pivot pin to a first intermediate lever, and the other end of the intermediate lever is connected in articulated fashion to a second intermediate lever, which is articulated on the toggle switch.

The link pin, with which the two intermediate levers are connected to one another, is guided in a slot of a rotatably mounted latching lever.

A release lever is also provided, with which the latching lever forms a latching point.

The release elements, i.e. thermal and magnetic releases, act on the switching mechanism at the release lever, the levers being arranged and interacting with one another in such a way that, in the event of renewed making, the switching sequence “auxiliary contact leading, main contact lagging” is implemented.

A contact pressure spring acts at the contact lever and attempts to press the movable contact piece with a given contact force against the fixed contact piece.

In the case of known generic switches, a tripping spring in the form of a compression spring acts on the control lever and attempts to press said control lever against the force of the contact pressure spring in the direction of tripping of the main contact point. The tripping spring in this case requires a large amount of space, and its spring force on the control lever always acts in the same direction. In this case it must still be able to exert a sufficiently great force on the control lever to compensate for the force of the contact pressure spring, even in the partially unstressed state. In this case, the compressive force of the tripping spring acts directly on the latching point and determines the unlatching force which needs to be applied by the thermal release for unlatching purposes.

Thus, in known generic switches there is the problem that the tripping spring needs to satisfy two opposing requirements. In order to ensure safe tripping, the force which it exerts on the control lever should be as great as possible. In order to ensure safe unlatching by the thermal release, however, this force should be as small as possible. In known generic switches, a compromise is always made, and neither of the requirements is entirely met.

### SUMMARY OF THE INVENTION

An aspect of the present invention is to provide a generic switch in such a way that a great force is exerted on the control lever and, at the same time, a small force is exerted on the latching point.

In accordance with the invention, the tripping spring therefore acts on the pivot pin, which connects the control lever and the first intermediate lever, and, via the pivot pin, loads the control lever in the direction of tripping of the main contact point, the introduction of force of the tripping spring onto the pivot pin being designed in such a way that a first, relatively small partial force acts in the direction of the latching point, and a second, relatively great partial force acts on the control lever.

In accordance with the invention, the tripping spring therefore no longer acts directly on the control lever, but on the pivot pin, which connects the control lever to the first intermediate lever. As a result, the direction of the introduction of force is selectable and can thus be designed in such a way that the force of the tripping spring is split into two components, of which one component acts in the direction of the latching point and a second component acts on the control lever in the direction of tripping. The introduction of force is in this case designed in such a way that the first partial force acting in the direction of the latching point is as small as possible and only the second partial force acting on the control lever is as great as possible.

In accordance with a particularly advantageous embodiment of the invention, the tripping spring is a torsion spring, also known as a leg spring, whose first leg is supported on a fixed point and whose second leg is used for the introduction of force onto the pivot pin.

Torsion springs are spiral springs which are wound in three dimensions with a linear torque characteristic. The introduction of force or torque takes place via the legs at the start and end of the spring. They can be matched in a variety of ways to the respectively provided physical conditions. By using a torsion spring to implement the present invention, the restricted space in the interior of the electrical switch according to the invention can therefore be utilized particularly well.

Very advantageous in this case is an embodiment in which the torsion spring is wound around the fixed rotary spindle of the contact carrier of the isolating contact point. Then, the rotary spindle of the contact lever acts as a working mandrel, against which the torsion spring bears with its inner coil opening and is held thereby. The rotary spindle of the contact carrier of the isolating contact point thus has an additional function, and no separate holder for the torsion spring is required.

### BRIEF DESCRIPTION OF THE DRAWINGS

The invention and further advantageous configurations and improvements of the invention will be explained and described in more detail with reference to the drawings, which illustrate an exemplary embodiment of the invention and in which:

FIG. 1 shows the switching mechanism of a switch according to the invention in the closed position, and

FIG. 2 shows the switching mechanism shown in FIG. 1 with the main and auxiliary contacts open.

### DETAILED DESCRIPTION

The switching mechanism has a main contact point 10 with a fixed contact piece 11 and a movable contact piece 13, which is fastened on a contact lever 12.

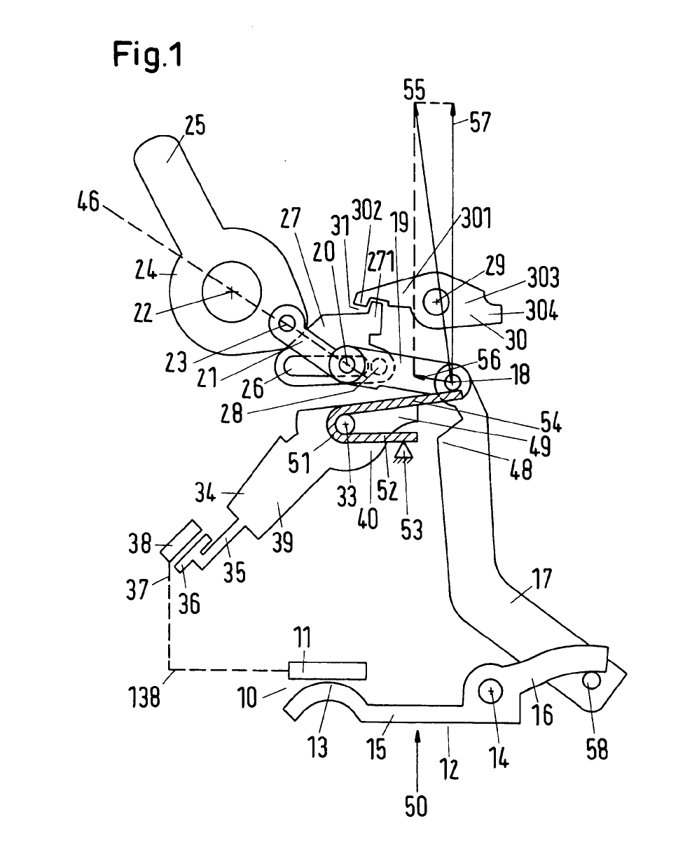

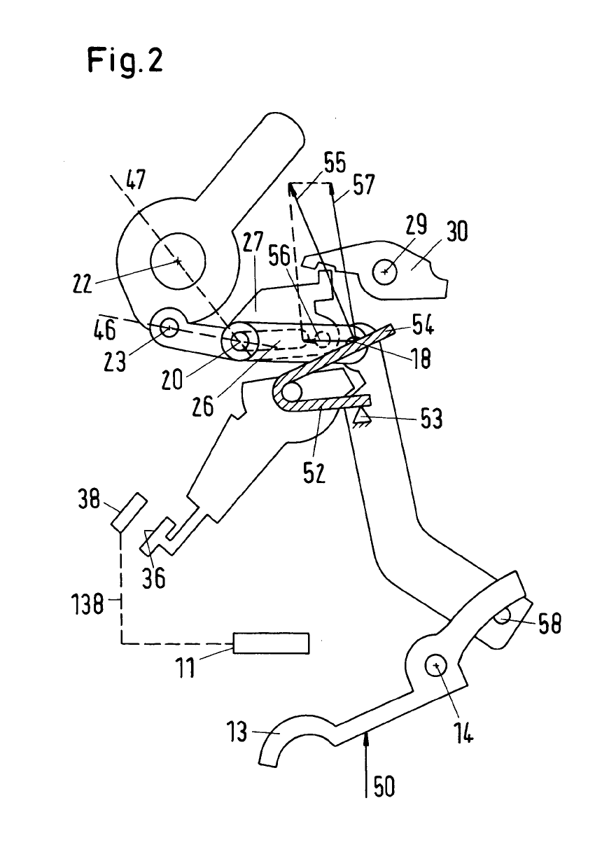

The contact lever 12 is mounted rotatably on a fixed rotary spindle 14 and is in the form of a twin-armed lever, whose first arm 15 bears the contact piece 13 and whose second arm 16 is acted upon by a control lever 17, which moves the contact lever 12 out of the making position (see FIG. 1) into the tripping position (see FIG. 2).

A contact pressure spring (not illustrated) acts at the contact lever and attempts to press the movable contact piece 13 against the fixed contact piece 11 with the contact force indicated by the arrow 50.

The control lever 17 is connected to a first intermediate lever 19 via a pivot pin 18. Said intermediate lever 19 is connected in articulated fashion to a second intermediate lever 21 via a link pin 20, which intermediate lever 21 is articulated on a toggle switch 24 with a switching handle 25 on an articulated spindle 23. The toggle switch 24 is mounted on a fixed spindle 22.

The link pin 20 is guided movably in a slot 26 of a latching lever 27. The latching lever 27 is mounted fixed in position in such a way that it can rotate about a rotary spindle 28. The latching lever 27 forms a latching point 31 with a release lever 30, which is mounted in such a way that it can rotate about a fixedly mounted spindle 29.

The release lever 30 is in the form of a twin-armed lever, whose first arm 301, which is inclined towards the latching point, bears a tab 302, which, together with a tab 271 of the latching lever 27, forms the latching point 31. The second arm 303, which points away from the latching point 31, of the release lever 30 bears a tab 304. The thermal release(s) of the switch act on this tab 304, for example via slides (not illustrated here). As a result of the action of the thermal releases, the release lever 30 is pivoted in the clockwise direction in the event of an operation of the release, with the result that the tab 302 releases the tab 271, as a result of which the latching point 31 is unlatched. In this case, the thermal releases need to overcome at least the force with which the tab 271 acts on the tab 302, which is therefore referred to as the unlatching force.

A fixed rotary spindle 33 is provided between the connecting line which connects the fixed rotary spindle 28 of the latching lever 27 and the fixed spindle 22 of the toggle switch 24, and the contact point 10, with a contact carrier 34, which bears a contact lever 35, being mounted on said rotary spindle 33.

The movable contact piece 36 of an isolating contact point 37 is fastened at the free end of the contact lever 35. The isolating contact point 37 has a fixed contact piece 38, which can be connected, fixed in position and electrically conductively, to the fixed contact piece 11 of the main contact point 10, indicated by a dashed connecting line 138.

The contact carrier 34 is in the form of a twin-armed carrier. One arm 39, which faces the main contact point 10, bears the contact lever 35 and the movable contact piece 36. The second arm 40, which projects in the opposite direction, has a projection 49.

A tab 48, which interacts with the projection 49 on the contact carrier 34 in such a way that the isolating contact point 37 opens after the opening of the main contact point 10 in the event of an opening operation of the main contact point 10 and is already closed prior to the closing of this main contact point 10 in the event of the closing of the main contact point 10, is integrally formed on the control lever 17.

The connecting line between the link pin 20 and the articulated spindle 23 which has the reference numeral 46 runs, in the tripping position shown in FIG. 2, below the connecting line 47, which runs between the link pin 20 and the fixed spindle 22 of the toggle switch 24. This is the first stable position of the switching mechanism in the tripping position.

In the making position shown in FIG. 1, the connecting line 46 runs above the fixed spindle 22. This is the second stable position of the switching mechanism in the making position.

A torsion spring 51 is wound around the fixed rotary spindle 33 of the contact carrier 34. A first leg 52 of the torsion spring 51 is supported on a fixed point 53. This fixed point 53 can be a projection or a depression on the inner side of the housing wall of the switch, but it may also be a mounting point on the printed circuit board holder of the switching mechanism.

A second leg 54 of the torsion spring 51 is supported at its free end against the pivot pin 18, which connects the control lever 17 to the first intermediate lever 19. The introduction of the spring force onto the pivot pin 18 therefore takes place via the second leg 54 of the torsion spring 51. The spring force which is introduced onto the pivot pin 18 perpendicular to the second leg 54 at the point of touching contact between the leg 54 and said pivot pin 18 is denoted by an arrow 55. It is split into a first, relatively small partial force, denoted by the arrow 56, which is directed into the first intermediate lever 19, and into a second, relatively great partial force, denoted by the arrow 57, which attempts to shift the control lever 17 in the direction of “opening of the main contact point 10”.

Only the first, relatively small partial force 56, which is directed into the first intermediate lever 19, generates the unlatching force at the latching point 31. This is relatively small, with the result that only a small release force needs to be applied by the thermal release, which force acts on the release lever 30 at the tab 304.

The second, relatively great partial force 57 is so great that it can overcome the contact pressure force 50 and can open the main contact point 10 and the isolating contact point 37 via the control lever 17. If appropriate, the second partial force 57 of the torsion spring 51 can be assisted in this case by the force of a further tension spring, which is articulated firstly on the control lever 17 and secondly on the second arm 40 of the contact carrier 34. This further tension spring is not illustrated here, but it is described, along with its function, in the abovementioned documents DE 195 26 591 and DE 195 26 592. The further tension spring is also not essential to the invention and not necessary for the operation of a switch according to the invention.

In the event of release, the release lever 30 would therefore be pivoted in the clockwise direction and in the process the latching point 31 would be released with the small unlatching force 56 being overcome. As a result, the link pin 20 in the slot 26 of the latching lever 27 is released and the control lever 17 can be pressed away from the fastening plane defined by the fixed contact piece 11 of the main contact point 10 and the rotary spindle 14 of the contact lever 12 as a result of the second, relatively great partial force 57. In this case, the control lever 17, via a guide pin 58, carries along the second arm 16 of the contact lever 12 and pivots the latter counter to the contact pressure force 50 and in the counterclockwise direction in such a way that the main contact point 10 is opened.

The arrangement of the link chain, which is formed from the first intermediate lever 19, the second intermediate lever 21 and the toggle switch 24 and interacts with the latching lever 27 via the link pin 20, which is guided in the slot 26, is affected in such a way that the toggle switch 24 is pivoted in the clockwise direction and the latching lever 27 is immediately pivoted into its latching position again, with the result that, if the thermal release has cooled down again and has moved back into its initial position, the latching point 31 is again latched. This position is illustrated in FIG. 2.

From the position illustrated in FIG. 2, renewed making of the switching mechanism is possible by the rotation of the switching handle 25 and therefore the toggle switch 24 in the counterclockwise direction. In this case, the torsion spring 51 is then also stressed again.

### LIST OF REFERENCE SYMBOLS

10 Main contact point

11 Fixed contact piece of main contact point

12 Contact lever of main contact point

13 Movable contact piece of main contact point

14 Rotary spindle

15 First arm of contact lever

16 Second arm of contact lever

17 Control lever

18 Pivot pin

19 First intermediate lever

20 Link pin

21 Second intermediate lever

22 Fixed spindle

23 Articulated spindle

24 Toggle switch

25 Switching handle

26 Slot

27 Latching lever

271 Tab

28 Rotary spindle of latching lever

29 Spindle of release lever

30 Release lever

301 First arm of release lever

302 Tab

303 Second arm of release lever

304 Tab

31 Latching point

33 Fixed rotary spindle of contact carrier 34

34 Contact carrier

35 Contact lever of isolating contact point

36 Movable contact piece of isolating contact point

37 Isolating contact point

38 Fixed contact piece of isolating contact point

138 Connecting line

39 First arm of contact carrier

40 Second arm of contact carrier

46 Connecting line 20-23

47 Connecting line 20-22

48 Tab

50 Contact pressure force

51 Torsion spring, tripping spring

52 First leg of torsion spring

53 Fixed point

54 Second leg of torsion spring

55 Spring force

56 First partial force

57 Second partial force

58 Guide pin

49 Projection

1-3. (canceled)

4. An electrical switch with a main current path and an auxiliary current path comprising:
a first stationary contact piece;
a first moveable contact piece moveable to contact the first stationary contact piece at a main contact point so as to close the main current path;
a contact lever disposed pivotably on a first fixed rotary spindle and having a first arm and a second arm, wherein the first moveable contact piece is disposed on the first arm;
a second stationary contact piece;
a second moveable contact piece moveable to contact the second stationary contact piece at an isolating contact point so as to close the auxiliary current path, wherein a current is commutated from the main current path to the auxiliary current path in an event of a short circuit;
a contact carrier disposed pivotably on a second fixed rotary spindle, wherein the second moveable contact piece is disposed on the contact carrier;
a toggle switch configured to actuate the main and isolating contact points;
a first intermediate lever having a first end and a second end;
a control lever having a first end pivotably to the first end of the first intermediate lever via a pivot pin and a second end configured to act on the second arm of the contact lever;
a second intermediate lever pivotably connected at a first end to the second end of the first intermediate lever via a link pin and at a second end to the toggle switch;
a latching lever mounted rotatably and having a slot, wherein the link pin is moveably disposed in the slot;
a release lever configured to form a latching connection with the latching lever at a latching point; and
a tripping spring configured to act on the pivot pin with a main force, wherein the main force includes a first partial force component acting on the latching point and a second partial force component acting on the control lever in a direction of tripping the main contact point, wherein the second partial force component is greater than the first partial force component.

5. The electrical switch as recited in claim 4, wherein at least one of the toggle switch, the first intermediate lever, the second intermediate lever, the latching lever, and the release lever are mounted in a printed circuit board holder.

6. The electrical switch as recited in claim 4, wherein the tripping spring is a torsion spring having a first leg supported on a fixed point and a second leg configured to introduce the force onto the pivot pin.

7. The electrical switch as recited in claim 6, wherein the torsion spring is wound around the second fixed rotary spindle.
